(19) United States
(12) Patent Application Publication
(10) Pub. No.: US 2011/0074909 A1
(43) Pub. Date: Mar. 31, 2011

(54) VIDEO TELEPHONY

(75) Inventors: Rahul Dinkar Sadafule, Bangalore (IN); Francois Martin, Paris (FR)

(73) Assignee: NXP B.V., Eindhoven (NL)

(21) Appl. No.: 12/992,564

(22) PCT Filed: May 18, 2009
(86) PCT No.: PCT/IB09/52052

§ 371 Date: Dec. 8, 2010

(30) Foreign Application Priority Data
May 16, 2008 (EP) 08103999.2
May 18, 2009 (IB) PCT/IB2009/052052

(51) Int. Cl. H04N 7/14; H04N 5/765

(52) U.S. Cl. 348/14.1; 386/200; 348/E07.077; 386/E05.001

(57) ABSTRACT

A method of recording a video telephony call, the method comprising: setting up a call between a first terminal (110) and a second terminal (120); sending a recording consent request (140) from the first terminal to the second terminal; receiving a recording consent response (150) at the first terminal from the second terminal; and recording outgoing and incoming audio and video data frames from the first terminal.

### TECHNICAL FIELD OF THE INVENTION

The invention relates to video telephony, and in particular to recording and playback of video telephony calls.

### BACKGROUND OF THE INVENTION

Real-time video, audio and data communication can be provided over radio networks using 3G-324M-compliant terminals. The 3G-324M standard is designed for wireless environments, where high bit error rates are common and bandwidth is limited. The standard operates over circuit-switched networks, thus avoid the current limitations of IP (i.e. packet-switched) networks, where latency is a significant problem for real-time video telephony (VT), and in particular for video streaming and video conferencing.

Whereas call recording of audio telephone conversations has been possible for many years, recording of video telephony calls, including both audio and video data, is more problematic. At present there are few commercially available 3G-324M systems that even claim to support recording of a VT call, and those that do support recording tend to support only limited functionality such as being able to record only received audiovisual (AV) streams. Also, playback of recorded VT calls is not prevalent, although recording of received AV streams is known. Playback of such streams is currently possible, as with any other type of recorded video file.

As well as technical issues, there are also legal implications of 3G-324M call recording that are not clear at present. Providing support for VT call recording therefore requires solutions to at least the following problems:

i) How to obtain consent from the remote party for call recording.

ii) How to record a VT call.

iii) Choice of an appropriate file format for storing the call record.

iv) How to playback a recorded VT call.

### OBJECT OF THE INVENTION

It is an object of the invention to address one or more of the above mentioned problems.

### SUMMARY OF THE INVENTION

In accordance with a first aspect of the invention there is provided a method of recording a video telephony call, the method comprising:

setting up a call between a first terminal and a second terminal;

sending a recording consent request from the first terminal to the second terminal;

receiving a recording consent response at the first terminal from the second terminal; and

recording outgoing and incoming audio and video data frames on the first terminal.

In accordance with a second aspect of the invention there is provided a method of recording a video telephony call, the method comprising:

setting up a call between a first terminal and a second terminal; and

recording outgoing and incoming audio and video data frames on the first terminal,

wherein the outgoing and incoming data frames are recorded on the first terminal in respective separate files, a common time reference being applied to each separate file for synchronizing the recorded video data frames.

In accordance with a third aspect of the invention there is provided a video telephony terminal comprising:

means for setting up a call between the terminal and a second terminal;

means for sending a recording consent request message to the second terminal;

means for receiving a recording consent response message from the second terminal; and

means for recording outgoing and incoming audio and video data frames.

In accordance with a fourth aspect of the invention there is provided a video telephony terminal comprising:

means for setting up a call between the terminal and a second terminal; and

means for recording outgoing and incoming audio and video data frames,

wherein the terminal is configured to record the outgoing and incoming data frames in respective separate files, and to apply a common time reference to each separate file for synchronizing the video data frames.

### BRIEF DESCRIPTION OF THE DRAWINGS

The invention will now be described by way of example and with reference to the accompanying drawings, in which:

FIG. 1 is a schematic diagram of a VT call set up between a pair of terminals, including a consent request and response;

FIG. 2 is a schematic diagram of media flow in a VT terminal in the case of VT call recording;

FIG. 3 is a schematic flow diagram illustrating a method of playback of a VT recording; and

FIGS. 4a to 4d illustrate exemplary output window configurations for playback of a VT recording.

### DETAILED DESCRIPTION OF THE DRAWINGS

Recording of a 3G-324M VT call as described herein may be defined as passive capture and storage of received and transmitted audio and video data during a video call. A recording does not require capture and storage of the 3G-324M protocol H.223/H.245 negotiations or of the 3G-324M bitstream itself, as is carried by some 3G-324M test equipment. Instead, only the video and audio information, after being demultiplexed but before decoding (for received signals) or after encoding and before multiplexing (for transmitted signals) is stored.

It is an important requirement for call recording to request and obtain consent. 3G-324M or its constituent protocols do not provide a standard means for achieving such consent. The following method is therefore proposed, which utilizes elements of the 3G-324M standard to realize this requirement.

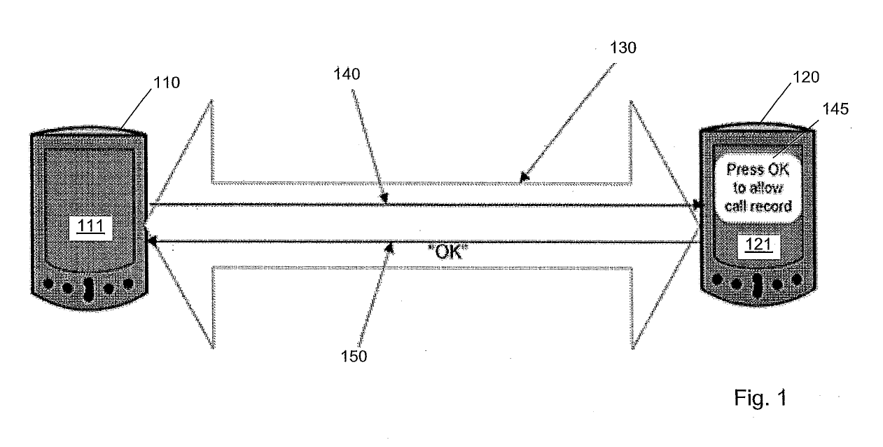

After a call has been established between a first and second terminal, a video or picture is streamed from the first terminal to the second terminal over a CS (circuit-switched) channel of the video logical channel of the 3G-324M call. The terminals make use of the ITU-T H.245 control mechanism that allows for exchange of alphanumeric characters during a 3G-324M call. This mechanism is depicted in FIG. 1. A video telephony call is set up between a first terminal 110 and a second terminal 120, the call being conventionally set up using a two-way 64 kbps CS channel 130. Each terminal 110, 120 is equipped with a screen 111, 121 for displaying incoming (and optionally also outgoing) video frames.

Using the H.245 protocol, a consent request message 140 is sent from the first terminal 110 to the second terminal 120. The message 145, as shown in FIG. 1 on the screen 121 of the second terminal 120, could be of the form “Press OK to allow call Record by user A” (user A being the user of the first terminal 110). In that case user B (the user of the second terminal 120) is warned that user A intends to record the VT call, and is asked to provide his consent, e.g. by pressing a predefined key. A message 150, indicating that user B has accepted recording, is then transmitted via the H.245 protocol to the first terminal 110. The message is defined in the H.245 protocol as being a User Input Indication (UII) message, the message containing ASCII code of the input from the second terminal, such as that of a particular key (or sequence of keys) selected by the user. Depending on the message received, a recording can be taken (if consent is given) or not (if no consent is given). In the case where no key is pressed by user B during a pre-defined period of time, or where a different key than the one indicated in the consent request message is selected, the first terminal considers that no consent has been given and will not permit call recording. Once user A has initiated the consent request, recording of the VT call preferably proceeds automatically upon receiving an affirmative consent response from the second terminal.

The consent request message 140, 145 can be sent to the second terminal in a number of ways, and may be shown as part of a still picture or video clip. The message 145 can be superimposed on the outgoing video of the first terminal 110, and received by the second terminal 120 as a composite image, with the consent request and response transmitted via the H.245 protocol. The user of the second terminal 120 could then continue to view incoming video from the first terminal. Alternatively, the consent request message could be presented to the user of the second terminal in the form of an audio message instead of (or in addition to) a superimposed image or video on the second terminal.

In order to avoid recordings being made where no consent is forthcoming from the second terminal, each terminal may be configured to provide consent in the form of a signed consent response. Signing of the consent may be achieved, for example, by public/private key encryption methods, with the second terminal user causing the terminal to encrypt the consent message using a private key, and then sending the encrypted consent message to the first terminal. The first terminal, which does not have access to the private key of the second terminal but does have access to the second terminal's public key, is then able to decode the consent message with the second terminal's public key. In this way, a non-repudiatable confirmation is provided to the first terminal that can be stored along with the recorded AV streams.

The above method of obtaining recording consent is expected to work with many, if not all, existing 3G-324M terminals. The only requirement is that both terminals support H.245 UII (User Input Indication) in the transmit direction, which is usually an mandatory feature in any 3G-324M implementation.

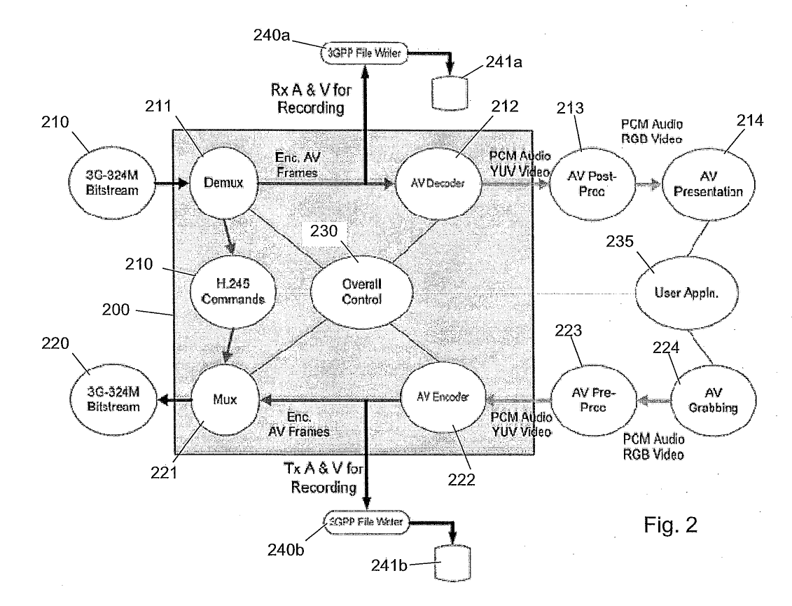

A VT media flow scheme is illustrated in FIG. 2, which shows the various processing steps associated with a VT-enabled terminal, with the 3G-324M-related processing steps shown within the box 200. An incoming 3G-324M bitstream 210 is first demultiplexed by a demultiplexer 211. Encoded AV frames are sent from the demultiplexer 211 to an AV decoder 212, while other components of the bitstream, such as H.245 control messages, are dealt with separately, for example by means of an H.245 command process 210 under control of an overall controller 230. The overall controller 230 also controls the demultiplexer 211, the incoming AV decoder 212, outgoing AV encoder 222 and outgoing multiplexer 221. The overall controller 230 provides one or more Application Programming Interfaces (APIs) for the user applications 235 to allow the user to control operation of the terminal.

The AV decoder 212 decodes the AV frames and forwards separate audio and video frames, for example in the PCM audio format and YUV video format, to an AV post-processing module 213, which processes and transforms the video into a format suitable for display on the terminal screen. The display format may be RGB or another format dependent upon the capabilities and requirements of the display driver interface. The incoming video and audio is then presented 214 to the user, under control of a user application 235.

The user application 235 also controls AV frame grabbing 224, for example from a video camera and microphone on the terminal. PCM audio and RGB video is sent to an AV pre-processing module 223, which transforms the video into YUV format, and forwards to the AV encoder 222. Other formats may alternatively be used, dependent on the camera driver interface. The AV encoder encodes the AV frames into a format compliant with a 3G-324M specification, and sends the encoded AV frames to the multiplexer 221. An outgoing multiplexed bitstream 220 is then transmitted, including any H.245 commands issued by the command module 210, for example in response to a user input as described above.

When recording AV frames (once consent has been given), received and transmitted frames are also forwarded to respective 3GPP-compatible file writers 240a, 240b, and separate files are stored in file stores 241a, 241b. The file stores 241a, 241b may be parts of a common file store, for example in the form of a disc drive or flash memory unit.

An advantage of ‘tapping’ the AV frames in the above-described way is that the method does not involve any re-encoding of the audio and video data. This reduces the processing load on the terminal, since recording will be taking place at the same time as a VT call, which will require substantial processing power. Saving the AV frames prior to decoding (or after encoding) also saves storage space on the storage medium used, allowing more calls to be recorded. The method also avoids a reduction in quality that could result from successive decoding and encoding of AV frames.

The encoded audio frames in the above described scheme can be in any one of a number of formats, such as AMR-NB, AMR-WB or G.723.1 streams. The encoded video frames can be in any one of a number of formats such as MPEG-4, H.263 or H.264 streams.

In a two-way AV call, there will be four streams in total to be recorded, which may be termed “near-end” (i.e. generated locally) audio and video, and “far-end” (i.e. received) audio and video. The proposal is to store each of the AV streams (near-end and far-end) in two separate 3GPP files by the use of the 3GPP file writers 240a, 240b as depicted in FIG. 2. The incoming and outgoing streams in the 3G-324M call could start at different times, so an important requirement in recording is to maintain a correct time relationship between the incoming and outgoing AV streams, so that they can be replayed synchronously. This is achieved by providing a common time reference to the 3GPP file writers 240a, 240b, so that the common time reference is applied to each separate file on recording, and subsequently used for synchronizing the incoming and outgoing video data frames.

As mentioned above, the AV streams in both the incoming and outgoing directions are stored in two 3GPP files. In order to reflect the recording of the VT session, these two 3GPP files need to be associated with each other. One way of achieving this is to use a reference file, for example in the form of a text file (e.g. in XML format), in which a reference is made to each of the two 3GPP files. The reference file may comprise various information relating to the separate 3GPP files, together with instructions on how to play and synchronise the files. The reference file may also contain details of the recording consent request and response messages, for example including the signed consent of the second terminal.

To support (for example) encapsulation of G.723.1 audio streams in the 3GPP file format, the format in which the files are stored may be extended beyond the standard 3GPP format. Playback of a file containing G.723.1 audio might not therefore be possible with other 3GPP-compliant media players. This would not necessarily be a problem if files stored on one terminal are not intended for being transferred to other terminals.

The AMR-NB frames in a 3G-324M call are of Interface Format 2 (IF2) type. A format conversion will therefore be required to store AMR-NB frames in the 3GPP file storage format.

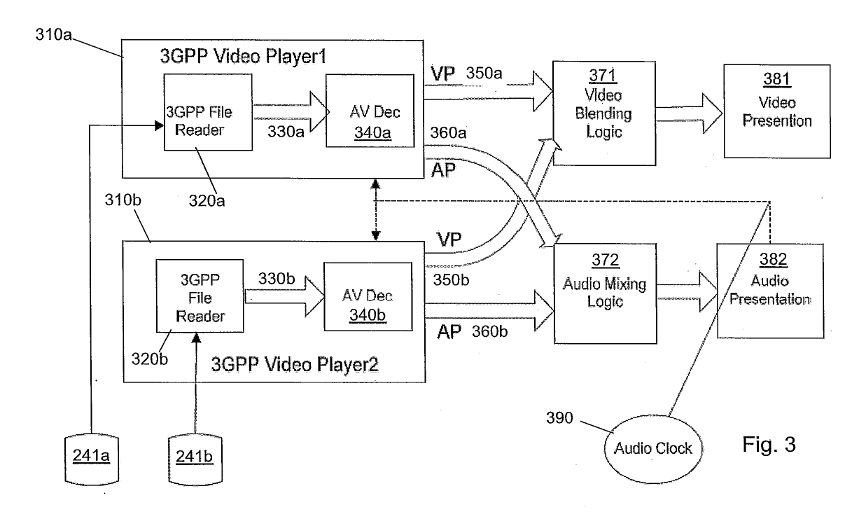

A 3GPP-compliant media player on the terminal/handset can be used to playback one or both of the two 3GPP files (bearing in mind the possible limitation related to G.723.1 audio support as described above). Playback of the incoming and outgoing streams can be made simultaneously, and optionally mixed together on the same screen. FIG. 3 shows a media flow diagram of an exemplary arrangement for playing back incoming and outgoing AV streams stored in separate files in file stores 241a, 241b (which, as mentioned above, may be parts of a common file store). First and second video players 310a, 310b retrieve the files from respective file stores 241a, 241b by means of respective 3GPP file readers 320a, 320b. The file readers pass the encoded AV streams 330a, 330b to respective AV decoders 340a, 340b.

The AV decoders 340a, 340b each generate a video playback stream 350a, 350b and an audio playback stream 360a, 360b. The video playback streams 350a, 350b are passed to video blending logic 371 that mixes the video frames and presents the result to video presentation means 381, i.e. a display screen. Audio playback streams 360a, 360b are forwarded to audio mixing logic 372, which mixes the audio streams 360a, 360b and presents the result to audio presentation means 382, e.g. a speaker.

An audio clock 390 is used to synchronise the two video players 310a, 310b so that the video and audio signals are properly synchronised with each other. The audio clock 390 is derived from the sampling frequency used in the audio presentation 382 to output the mixed audio samples to a speaker. Video players 310a 310b can use the clock 390 as a common time reference to decode compressed AV frames based on the time stamps in the AV streams. The use of the common time reference stored in the files ensures that the presentation of the near end and far end streams is properly synchronised.

Audio information from each of the files will typically be mixed together when playing back the stored files. Such mixing may be a simple averaging of the incoming and outgoing audio samples, which is possible due to the audio samples being made at the same rate. Weighting of the incoming or outgoing samples, either carried out automatically or under the control of the user, may be made to compensated for differences in volume.

The stored files contain a common time reference in the form of Composition Time Stamps (CTSs), so the files can be synchronized on playback. Since the CTSs may be derived using the same time reference during recording (e.g. from an internal clock in the receiving terminal), the time relation between near end and far end AV as displayed can be automatically maintained.

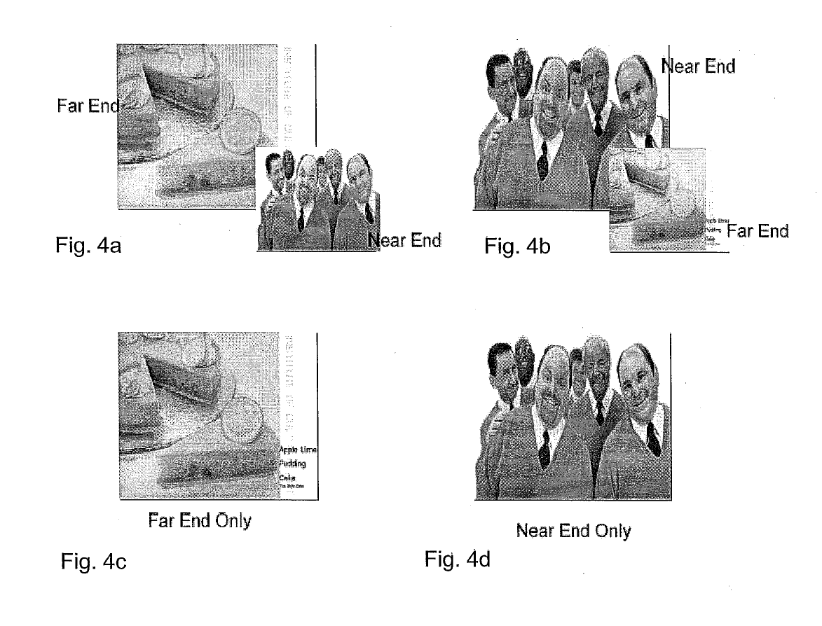

Similar to a typical Video Telephony use case, at least four different kinds of presentation of the output video are possible during playback of a recorded Video Telephony call, enabled by the video blending logic 371. These are illustrated by example in FIG. 4, and include:

i) Presentation of the near end video only (FIG. 4a);

ii) Presentation of the far end video only (FIG. 4b);

iii) Presentation of the near end video with presentation of the far end video in picture-in-picture style (FIG. 4c); and

iv) Presentation of the far end video with presentation of the near end video in picture-in-picture style (FIG. 4d).

Selection of which type of presentation is to be used can be made by a user of the playback terminal.

Although the invention is primarily directed at recording of AV calls over 3G-324M, aspects of the invention could also be used in recording of AV calls over IP, as defined in the 3GPP MTSI (Mobile Telephony Services Over IMS) specifications 26.914 and 26.114 (references [5] and [6] below). Over time, as telephone networks develop and problems relating to IP networks are addressed, multimedia calls over IP may become more prevalent than calls over 3G-324M. In the case of calls over IP, the H.245 command is not available since the protocols used are different. A consent request and response may therefore be sent and received by communication of separate data packets between the first and second terminals.

Other embodiments are intentionally within the scope of the invention as defined by the appended claims.

Various acronyms are used herein, or are relevant to implementations of the invention, explanations for which are provided below.

3GPP: 3rd Generation Partnership Project for UMTS technology with WCDMA air 3G interface.

3G-324M: Based on ITU-T H.324 recommendation modified by 3GPP for the purpose of 3GPP circuit switched network based video telephony.

VT: 3G-324M Based Video Telephony.

LC: ITU-T H.223 logical channel. In a typical 3G-324M call there are 2 audio, 2 video logical channels over the 64 KPBS V bearer. The ITUT H.245 also has 2 logical channels.

MPEG-4: Motion Pictures Experts Group-4 Simple Profile.

H.263: ITU-T H.263.

H.264: ITU-T H.264 standard (also known as ISO/IEC MPEG-4 Part 10).

AMR-NB: Adaptive Multi-Rate-Narrow Band (Audio Codec).

G.723.1: ITU-T G.723.1 Speech Coding Standard.

AMR-WB: ITU-T G.722.2 Speech Coding Standard.

ITU-T: International Telecommunication Union—Telecommunication Standardization Sector.

### REFERENCES

[1] 3GPP TS 26.110: “Codec for Circuit Switched Multimedia Telephony Service: General Description”.
[2] 3GPP TS 26.111: “Codec for Circuit Switched Multimedia Telephony Service, Modifications to H.324”.
[3] 3GPP TR 26.911: “Terminal Implementor's Guide”.
[4] 3GPP TS 26.101: “Adaptive Multi-Rate Speech Codec Frame Structure”.
[5] 3GPP TS 26.114: “IP Multimedia Subsystem (IMS); Multimedia Telephony; Media handling and interaction”.
[6] 3GPP TS 26.914: “Multimedia telephony over IP Multimedia Subsystem (IMS); Optimization opportunities”.
   Each of the above references can be obtained in full from the 3GPP website (www.3gpp.org), and each are incorporated by reference herein.

1. A method of recording a video telephony call, the method comprising:
setting up a call between a first terminal and a second terminal;
sending a recording consent request message from the first terminal to the second terminal;
receiving a recording consent response message at the first terminal from the second terminal; and
recording outgoing and incoming audio and video data frames at the first terminal.

2. The method of claim 1 wherein the outgoing and incoming data frames are recorded in respective separate files, a common time reference being applied to each separate file for synchronizing the recorded video data frames.

3. A method of recording a video telephony call, the method comprising:
setting up a call between a first terminal and a second terminal; and
recording outgoing and incoming audio and video data frames at the first terminal,
wherein the outgoing and incoming data frames are recorded at the first terminal in respective separate files, a common time reference being applied to each separate file for synchronizing the recorded video data frames.

4. The method of claim 2 wherein a reference file is created and stored with the separate files containing the recorded data frames, the reference file comprising references to each of the separate files.

5. The method of claim 1 wherein the video data frames are recorded in an encoded format.

6. The method of claim 1 wherein the video telephony call conforms to a 3G-324M standard.

7. The method of claim 1 wherein the video telephony call conforms to an internet protocol telephony standard.

8. The method of claim 6 wherein the recording consent request and response messages are communicated using H.245 control messages.

9. The method of claim 8 wherein the response message is a User Input Indication message.

10. The method of claim 1 wherein the recording consent request message is displayed at the second terminal superimposed on incoming video from the first terminal.

11. The method of claim 1 wherein the recording consent request message is provided in as an audio message output by the second terminal.

12. The method of claim 1 wherein the video data frames are encoded in an MPEG-4, H.263 or H.264 compliant format.

13. The method of claim 1 wherein the recording consent response message is signed by the second terminal.

14. The method of claim 2 wherein the common time reference is derived from a sampling frequency of the audio data.

15. A method of playing back a recorded video telephony call made according to claim 2, the method comprising:
reading and decoding the recorded video data frames to produce first and second video streams;
synchronizing the video streams with the common time reference; and
blending the video streams to generate a video presentation of the video telephony call.

16. The method of claim 15 wherein the video presentation is composed of a composite video of the recorded incoming and outgoing video data frames.

17. The method of claim 15 wherein the video presentation is composed of the recorded incoming or outgoing video data frames.

18. The method of claim 15, further comprising mixing the audio data from the recorded incoming and outgoing audio data to generate an audio presentation.

19. A video telephony terminal comprising:
means for setting up a call between the terminal and a second terminal;
means for sending a recording consent request message to the second terminal;
means for receiving a recording consent response message from the second terminal; and
means for recording outgoing and incoming audio and video data frames.

20. A video telephony terminal comprising:
means for setting up a call between the terminal and a second terminal; and
means for recording outgoing and incoming audio and video data frames,
wherein the terminal is configured to record the outgoing and incoming data frames in respective separate files, and to apply a common time reference to each separate file for synchronizing the video data frames.
